(19) United States
(12) Patent Application Publication
(10) Pub. No.: US 2006/0210734 A1
(43) Pub. Date: Sep. 21, 2006

(54) Composite material tube with inlaid element

(76) Inventor: A-Ping Lin, Changhwa City (TW)

Correspondence Address: CHARLES E. BAXLEY, ESQ., 90 JOHN STREET, THIRD FLOOR, NEW YORK, NY, 10038, US

(21) Appl. No.: 11/082,995

(22) Filed: Mar. 17, 2005

(51) Int. Cl. B32B 1/08

(52) U.S. Cl. 428/34.1; 428/36.9

(57) ABSTRACT

A composite material tube with inlaid element, on the outer periphery of the inlaid element are provided with a plurality of ribs which are to be engaged with a plurality of grooves in the composite tube, through the engagement of the ribs with the grooves, external-force-induced rotation of the inlaid element relative to the composite material tube can be eliminated. On the periphery of the inlaid element is further formed an annular groove for engaging with a projection of the composite material tube, through the engagement of the projection with the recess, an external-force-induced axial disengagement of the inlaid element from the composite material tube can be prevented.

### BACKGROUND OF THE INVENTION

1. Field of the Invention

The present invention relates to a composite material tube with inlaid element, and more particularly to a composite material tube that is used on bicycle.

2. Description of the Prior Arts

Currently, composite material tube with inlaid element is made by compression molding, wherein the inlaid element is pre-inlaid in the composite material, and then by being pressurized and heated in a mold, the inlaid element and the composite material are combined together.

As shown in FIGS. 1 and 2, a conventional composite material tube is inlaid with an inlaid element 10 which is an integrally formed ring-shaped structure for engagement other bicycle components. At the connection between the composite material tube 11 and the inlaid element 10 is formed a combining hole 12, and the composite material tube 11 abuts closely against the periphery of the inlaid element through the inner wall of the combining hole 12. This inlaying method has been used for a long period of time; however, it still has the problems as follows:

During movement of a bicycle, the rider's weight and the shock caused by the uneven road surface will be applied indirectly to the connection between the inlaid element 10 and the composite material 11, it will lead to an axial rotation of the inlaid element 10 relative to the combining hole 12 of the composite material tube 11, after a certain period of use, or even worse, the inlaid element 10 is likely to disengage from the combining hole 12 of the composite material tube 11. Therefore, the composite material tube 11 and the inlaid element 10 have to be replaced, increasing the maintenance cost. And if the user neglects or fails to perform maintenance, the above-mentioned problems will result in an accident or even endanger the user's safety.

The present invention has arisen to mitigate and/or obviate the afore-described disadvantages.

### SUMMARY OF THE INVENTION

The primary objective of the present invention is to provide a composite material tube with inlaid element, on the outer periphery of the inlaid element are provided with a plurality of ribs which are to be engaged with a plurality of grooves in the composite tube, through the engagement of the ribs with the grooves, external-force-induced rotation of the inlaid element relative to the composite material tube can be eliminated. Therefore, the ribs of the inlaid element increase the contact surface between the inlaid element and the composite material tube, meanwhile, the friction force between them increases.

The secondary objective of the present invention is to provide a composite material tube with inlaid element, on the periphery of the inlaid element is formed an annular groove for engaging with a projection of the composite material tube, through the engagement of the projection with the recess, an external-force-induced axial disengagement of the inlaid element from the composite material tube can be prevented, since both friction force and contact surface between the inlaid element and the composite material increase.

A composite material tube with inlaid element provided in accordance with the present invention comprises:

an integral-formed inlaid element having a ring shape, on an outer periphery of the inlaid element provided with a plurality of ribs and an annular recess;

a composite material tube made by compression molding at high temperature, during molding process, a combining hole will be formed correspondingly to profile of the composite material tube, and a plurality of grooves will be formed on an internal wall of the combining hole for engagement of the ribs of the inlaid element, and the combining hole will be formed with an annular projection correspondingly to the recess of the inlaid element.

The present invention will become more obvious from the following descriptions when taken in connection with the accompanying drawings, which show, for purpose of illustrations only, the preferred embodiments in accordance with the present invention.

### BRIEF DESCRIPTION OF THE DRAWINGS

FIG. 1 is a perspective view of a conventional composite material tube with inlaid tube;

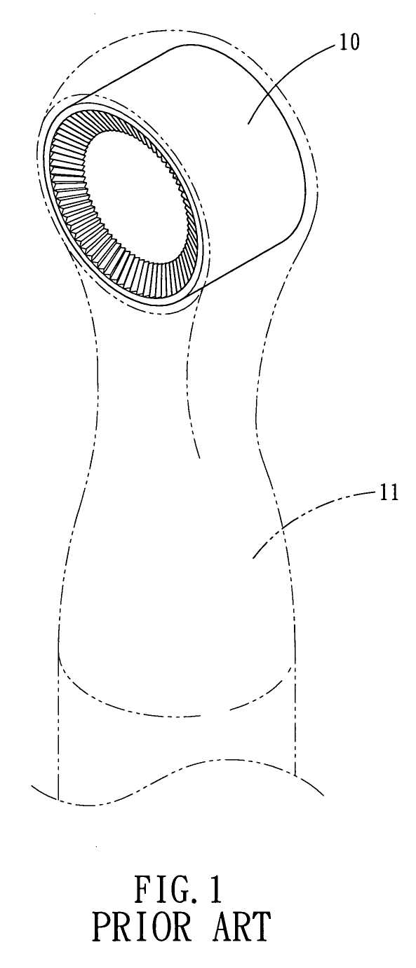

FIG. 2 is a cross sectional view of a conventional composite material tube with inlaid tube;

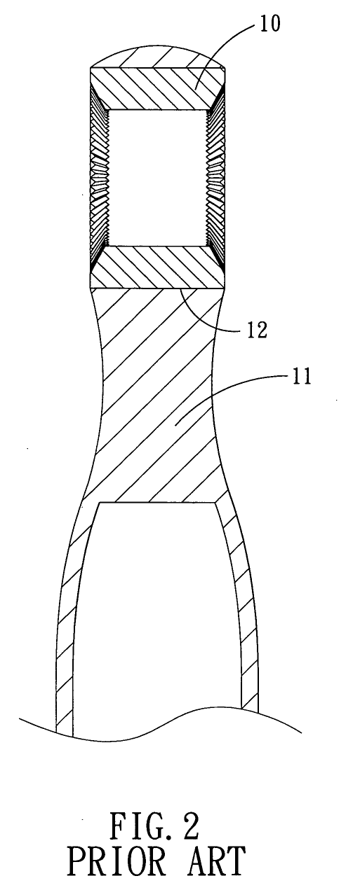

FIG. 3 is a perspective view of a composite material tube with inlaid tube in accordance with a first embodiment of the present invention;

FIG. 4 is a radial cross sectional view of the composite material tube with inlaid tube in accordance with the present invention;

FIG. 5 is an axial cross sectional view of the composite material tube with inlaid tube in accordance with the present invention;

FIG. 6 is a perspective view of a composite material tube with inlaid tube in accordance with a second embodiment of the present invention.

### DETAILED DESCRIPTION OF THE PREFERRED EMBODIMENTS

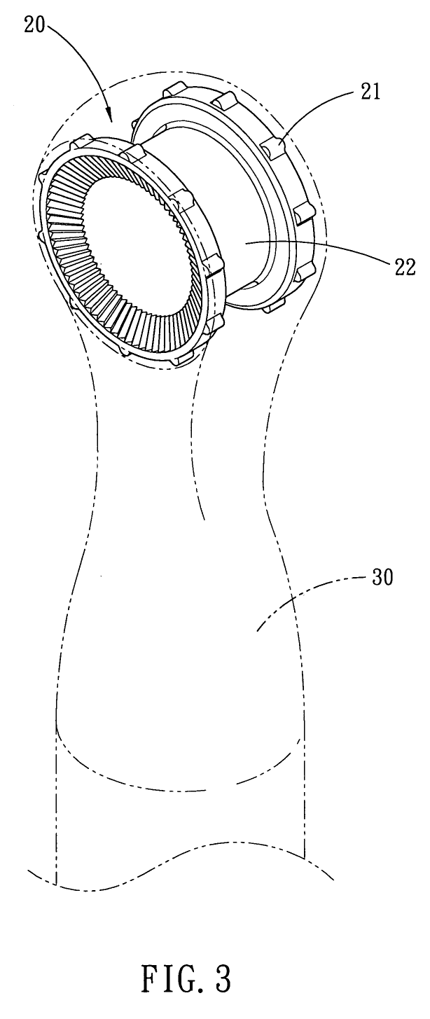

Referring to FIG. 3, a composite material tube 30 with inlaid element 20 in accordance with a preferred embodiment of the present invention is shown.

The inlaid element 20 is a metal unitary structure having a ring-shape and provided on the outer periphery thereof with a plurality of ribs 21 which are semicircle in cross section, at the mid portion of the outer periphery of the inlaid element 20 is annularly formed a recess 22.

The composite material tube 30 is made by compression molding at high temperature, during the molding process, a combining hole 31 will be formed correspondingly to profile of the composite material tube 30, and a plurality of grooves 32 will be formed on the internal wall of the combining hole 31 for engagement of the ribs 21 of the inlaid element 20. Furthermore, the combining hole 31 will be formed with an annular projection 33 correspondingly to the recess 22 of the inlaid element 20.

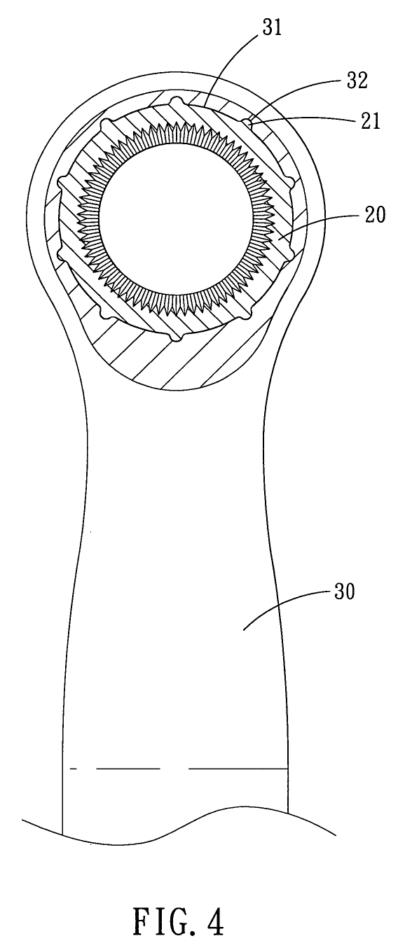

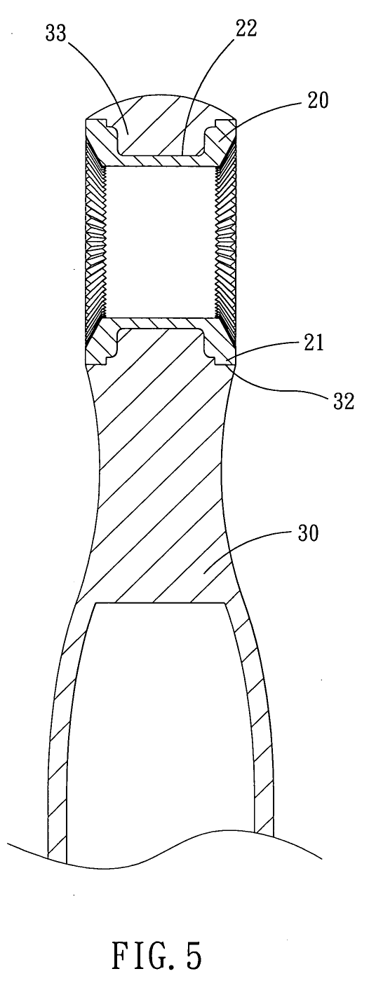

For a better understanding of the present invention, its operations and functions, references should be made to FIGS. 3-5. When the inlaid element 20 is being combined with the composite material tube 30, the design of the plurality of ribs 21 and the recess 22 on the outer periphery of the inlaid element 20 will enable the composite material tube 30 to be formed with the combining hole 31 correspondingly to the profile of the inlaid element 20, so that the outer periphery of the inlaid element 20 will abut closely against the inner wall of the combining hole 31 of the composite material tube 30.

The plurality of grooves 32 will be formed in the combining hole 31 for receiving the ribs 21 of the inlaid element 20.

The projection 33 will also be formed in the combining hole 31 for engagement of the recess 22 of the inlaid element.

The composite material tube 30 with the inlaid element 20 in accordance with the present invention has the following advantages:

First, through the engagement of the ribs 21 in the grooves 32, external-force-induced rotation of the inlaid element 20 relative to the composite material tube 30 can be eliminated. Therefore, the ribs 21 of the inlaid element 20 increase the contact surface between the inlaid element 20 and the composite material tube 30, meanwhile, the friction force between them increases.

Second, through the engagement of the projection 33 in the recess 22, an external-force-induced axial disengagement of the inlaid element 20 from the composite material tube 30 can be prevented, since both friction force and contact surface between the inlaid element 20 and the composite material tube 30 increase.

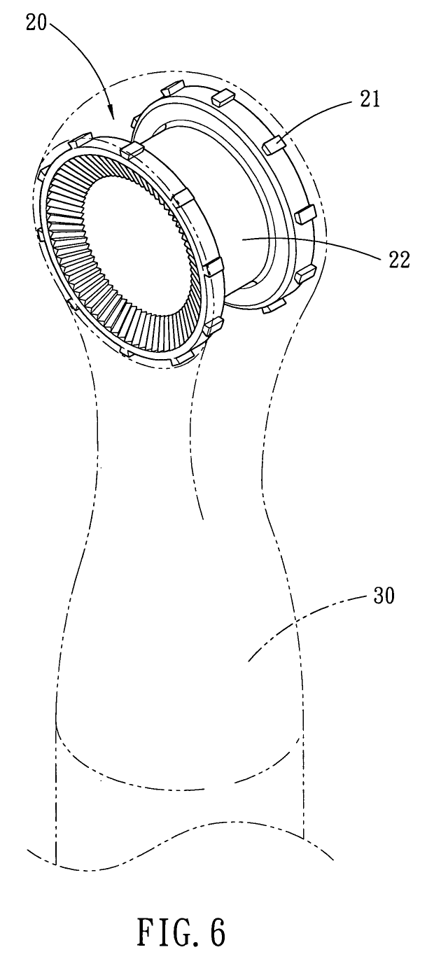

Referring to FIG. 6, a composite material tube with inlaid element in accordance with a second embodiment of the present invention is shown and similar to the first embodiment, except:

The ribs 21 of the inlaid element 20 are dovetail-shaped in cross section and also can enable the inlaid element 20 to be engaged with the composite material tube 30 firmly. Therefore, the ribs 21 of the inlaid element 20 can be any geometric shape in cross section.

While we have shown and described various embodiments in accordance with the present invention, it should be clear to those skilled in the art that further embodiments may be made without departing from the scope of the present invention.

What is claimed is:

1. A composite material tube with inlaid element comprising:
an integral-formed inlaid element having a ring shape, on an outer periphery of the inlaid element provided with a plurality of ribs and an annular recess;
a composite material tube made by compression molding at high temperature, during molding process, a combining hole will be formed correspondingly to profile of the composite material tube, and a plurality of grooves will be formed on an internal wall of the combining hole for engagement of the ribs of the inlaid element, and the combining hole will be formed with an annular projection correspondingly to the recess of the inlaid element.

2. The composite material tube with inlaid element as claimed in claim 1, wherein the ribs of the inlaid element are geometric-shaped in cross section.

3. The composite material tube with inlaid element as claimed in claim 2, wherein the ribs of the inlaid element are dovetail-shaped in cross section.

4. The composite material tube with inlaid element as claimed in claim 2, wherein the ribs of the inlaid element are semicircle-shaped in cross section.
